(19) United States
(12) Patent Application Publication
(10) Pub. No.: US 2005/0026697 A1
(43) Pub. Date: Feb. 3, 2005

(54) System, computer product and method for enabling multi-player gaming on a wireless device

(76) Inventors: Robert Eugene Balahura, Waterloo (CA); Mathieu Robert Adelard Trudel, Williamstown (CA)

Correspondence Address: MILLER THOMPSON, LLP, 20 QUEEN STREET WEST, SUITE 2500, TORONTO, ON, M5H 3S1, CA

(21) Appl. No.: 10/902,164

(22) Filed: Jul. 30, 2004

Related U.S. Application Data
(60) Provisional application No. 60/490,966, filed on Jul. 30, 2003.

(51) Int. Cl. G06F 19/00; G06F 17/00

(52) U.S. Cl. 463/42

(57) ABSTRACT

A system, computer program and method for enabling multi-player gaming on a wireless device is provided. At least one wireless device being is linked to a client application and to a memory, and associated with a first player. At least one remote network-connected device, consisting of a remote wireless device, an artificial intelligence player, or a client computer, the at least one remote network-connected device is associated with at least one second player. The wireless device an remote network-connected device are each connected to a communication network. The remote network-connected device is also linked to a client application generally corresponding to the client application. An intermediary server is operable to connect to each of the at least one wireless device and the at least one remote network-connected device. The client application enables the first player or at least one second player to send and receive a plurality of communications defining one or more steps involved in playing a game to and from the intermediary server, the intermediary server acting as a intermediary for gaming communications as between the at least one wireless device and the at least one remote network-connected device. The intermediary server is linked to a server application which in cooperation with the client application provides a multi-player gaming platform. The invention also includes a method of development of multi-player games to this multi-player gaming platform.

### FIELD OF THE INVENTION

This invention relates in general to gaming technologies for use on one or more network-connected devices, including a wireless device. This invention further relates to multi-player gaming technologies for use on wireless devices. This invention also relates to a system architecture for enabling multi-player gaming on at least one wireless device.

### BACKGROUND OF THE INVENTION

Wireless devices of numerous types are commonplace. First, there are WAP-enabled cell phones. These devices generally have a small text display and allow the user to set up a connection session to the Internet. Second, there are 2-way pager devices. These devices generally establish “session-less” connections to the Internet, i.e. they send and receive messages without the overhead of logging in, establishing credentials, etc. Examples of such 2-way paging devices include RIM's Blackberry™ pager that includes a memory. A third type of wireless device is known as a Wireless Personal Digital Assistant (PDA) or wireless terminal. These devices provide a small screen and permit inputting of text. Some wireless terminals include an ASCII keyboard. The wireless terminal operates similarly to the WAP-enabled cell phone, except the wireless terminal can generally support a richer user experience, e.g. colour screens and audio output and generally have more processing capability than WAP-enabled cell phones.

A fourth type of device is a cell phone that provides wireless Internet access using network connectivity other than WAP and in association with applications resident on the wireless device. Another aspect of such wireless devices is that they generally include a memory, such that applications can be loaded on the device, and data can be stored on the device itself.

References to wireless devices herein generally mean a wireless device or wireless devices that include a memory, such that they can receive applications and can store data to a memory linked to the device. Examples of such wireless devices include, for example, MOTOROLA's T720 and the Blackberry™.

The gaming software and device industry is relatively large. Gaming technology products are popular with consumers, and numerous companies are engaged in developing and exploiting technologies directed to this market demand.

A growing trend in the gaming industry is deploying games on wireless devices. Prior art technologies for use on wireless devices include, for example, the wireless gaming titles of Jamdat Mobile Inc. Jamdat Mobile Inc. sells a gaming platform that enables gaming in relation to a number of titles including, for example, SPACE INVADERS™. Another representative company producing wireless gaming technologies and publishing wireless gaming titles is Unplugged Games Inc.

A disadvantage of such wireless games is that they generally do not allow multi-player gaming. Multi-player Internet gaming is well known and very popular due in part to the social aspect of interplay with other individuals including friends but strangers also. In some cases one or more of the other players actually consists of a computer, or one or more Artificial Intelligence (AI) players. Even multi-play involving at least one AI player enables the advantages of multi-play such as for example competition with an opponent.

What is needed is a multi-player gaming platform that is easy and relatively inexpensive to deploy. There is a further need for a multi-player gaming facility that enables multi-player gaming between a plurality of network-connected devices, including wireless devices. In other words, there is a need for a gaming platform that enables the easy deployment of network-aware wireless games.

One of the attributes of a strong gaming platform, including wireless gaming platforms, is the roll out a wide selection of games on that platform. A wide selection of games is a significant contributor to market acceptance of a particular gaming platform. The selection should preferably include new games, but also adaptations of existing game titles with broad consumer following.

At present there are a number of barriers to maximizing the selection of game titles available on a wireless platform. Availability of a broad selection of games generally requires enabling a large number of game authors to write to a wireless gaming platform. Currently, developers of prior art wireless gaming platforms engage in game development in-house, or under co-development arrangement with third parties. Development of a game that will resonate with the wireless gaming user base can be unpredictable. Generally what is required is to open the wireless gaming platform to as many gaming authors possible. Developing a wireless game, however, can be complicated from a development and interoperability perspective. For example, creating a server that supports a wireless game, and also developing specialized API's and command protocols compliant with network requirements for each network game function can be complex.

Also, most wireless network operators will require certification of a game before enabling the game on their network. Obtaining such certification can be a time consuming and costly process. Also, from the perspective of a wireless network operator, there can be variance in the quality of games emanating from different authors. This variance in quality can cause frustration to the valuable game user base.

There is a need therefore for a wireless gaming platform that provides tools that enable rapid development and deployment of wireless game titles. There is a further need for a wireless gaming platform that stimulates the development of new wireless games and adaptation of existing games to a wireless gaming platform by means of easy game development and deployment. There is a still further need for an improved gaming platform for wireless multi-player gaming.

The J2ME™ platform refers to the “JAVA 2 PLATFORM, MICRO EDITION” which is a JAVA™ based platform from Sun Microsystems for consumer and embedded devices such as mobile phones, PDAs, and TV set-top boxes. One aspect of J2ME is that it enables rapid deployment of applications on wireless devices by providing a series of tools including easy to use API's, user interfaces, security features, support for networked and disconnected applications, and tools for managing the resources of particular wireless devices.

There is a further need for a solution that leverages J2ME to provide a wireless gaming platform, and particularly a multi-player wireless gaming platform for use as between one or more J2ME compliant wireless devices and one or more remote computer devices. There is a further need for a particular system architecture that enables the leveraging of J2ME to provide wireless gaming as between one or more J2ME compliant wireless devices and one or more remote computer devices. There is a further need for such a system architecture to enable multi-player gaming as between J2ME compliant wireless device.

### SUMMARY OF THE INVENTION

A multi-player gaming platform is provided that enables multi-player gaming involving at least one wireless device.

The system of the present invention includes a server computer. The server computer includes a server application that manages communications as between the at least one wireless device and the remote devices associated with the other players. The server application includes a server post office facility that receives a series of data communications from a device authorized by the access facility, and sends the data communications to the appropriate device. This occurs independent of gaming logic associated with a particular game.

A wireless application is linked to the at least one wireless device, and also the other remote devices. The wireless application includes logic defining the data communications, and processing of such data communications, required in order to play a particular multi-player game. The wireless application is adapted to receive data communications from the server computer and determine if such data communications relate to a multi-player game, and process the data communication in accordance with the logic defining a particular multi-player game. The wireless application is also adapted to poll the server computer for data communications related to a particular multi-player game.

The wireless application and the server application cooperate to provide a number of functions at the wireless device related to multi-player gaming. One such function enables a user associated with the wireless device to be matched for multi-player gaming with a user of another wireless device, an Internet client user, and/or an artificial intelligence player.

A still other aspect invention is a development toolkit that enables game developers to develop and deploy games to the multi-player gaming platform of the present invention with relative ease and efficiency.

A still other particular aspect of the present invention is a method that enables game developers to develop and deploy games to the multi-player gaming platform of the present invention using the development toolkit.

An object of the present invention is to provide a system, computer program and method for enabling multi-player gaming involving at least one wireless device.

The multi-player gaming platform described enables multi-player gaming between at least one wireless device and one or more Internet client or artificial intelligence player.

In one aspect of the present invention, there is provided A method for providing multi-player gaming on a wireless device including the steps of: providing on the wireless device a wireless application that enables a user associated with the wireless device to send and receive a plurality of communications defining one or more steps involved in playing a game to at least one remote network-connected device consisting of at least one of a remote wireless device, an artificial intelligence player and/or a remote client computer, via an intermediary server, the at least one remote network-connected device being linked to a wireless application generally corresponding to the wireless application; sending a request for multi-player gaming to the intermediary server from the wireless device; in response to matching the user associated with the wireless device with at least one other player associated with the at least one remote network-connected device, by operation of a matching facility linked to the intermediary server; activating a multi-player game linked to the wireless application, thereby enabling the user to make one or more initial moves by providing input to the wireless application, thereby engaging the wireless application to assemble a gaming communication, and deliver the gaming communication to the intermediary server; and each of the user and the at least one other player thereafter polling the intermediary server for a plurality of gaming communications consisting of moves from the at least one network-connected device, said gaming communications being interpreted by the wireless application in accordance with the multi-player game, and in response to such game communications, each of the user and the at least one other player making further moves by providing input to the wireless application or the corresponding wireless application, thereby engaging the wireless application or the corresponding wireless application to assemble further gaming communications, and deliver the further gaming communications to the intermediary server, until an end game defined by the multi-player game is achieved.

In another aspect of the present invention, there is provided a system for providing multi-player gaming on a wireless device including: at least one wireless device being linked to a client application and to a memory, and associated with a first player; at least one remote network-connected device, consisting of a remote wireless device, an artificial intelligence player, or a client computer, the at least one remote network-connected device being associated with at least one second player, the at least one remote network-connected device also being linked to a client application generally corresponding to the client application, and further linked to a memory; an intermediary server operable to connect to each of the at least one wireless device and the at least one remote network-connected device, the intermediary server client computer and the wireless device, the intermediary server being linked to a server application and a server database; wherein the client application enables the first player or at least one second player to send and receive a plurality of communications defining one or more steps involved in playing a game to and from the intermediary server, the intermediary server acting as a intermediary for gaming communications as between the at least one wireless device and the at least one remote network-connected device; wherein the client application is operable to send a request for multi-player gaming to the intermediary server from the at least one wireless device, and in response the server application is operable to match the first player with the at least one second player, by operation of a matching facility linked to the intermediary server; wherein the client application and the corresponding client application are linked to a gaming utility that includes at least one multi-player game that enables the first player and the at least one second player to make one or more moves, and in response to such moves the client application being operable to assemble a corresponding one or more gaming communications for delivery to the intermediary server; and wherein the client application is further operable to poll the intermediary server for gaming communications received from the other matched players, namely the other of the first player or the at least one second player, and to interpret the polled gaming communications in accordance with the multi-player game, and in response to such game communications, each of the first player and the at least one second player making further moves by providing input to the gaming utility, thereby engaging the client application to assemble further gaming communications, and deliver the further gaming communications to the intermediary server, until an end game defined by the multi-player game is achieved.

In yet another aspect of the present invention, there is provided a method of creating multi-player games operable as between a wireless device and at least one other remote network-connected device including the steps of: providing a server computer linked to a server application and a client application operable on a wireless device, the server application and the client application being operably linked to provide a multi-player gaming platform, the multi-player gaming platform consisting of a plurality of utilities that enable multi-player gaming, such utilities including a matching utility for matching a first player associated with a wireless device with at least one second player associated with another wireless device, an artificial intelligence player or a client computer, and also one or more of the following utilities: a buddy list facility; a chat facility; a contest facility; a ranking facility, and/or an SMS facility; providing a toolkit that enables the development and deployment of one or more multi-player games, whereby the toolkit includes at least one game interface that enables game content including one or more of graphics, text, and game logic to be created that is operable to interface with the multi-player gaming platform, thereby enabling the creation of a multi-player game that interoperates with the matching utilities and one or more of the buddy list facility, the chat facility, the contest facility, the ranking facility and/or the SMS facility; and creating one or more multi-player games to the at least one game interface.

In a further aspect of the present invention, there is provided a computer program for enabling multi-player gaming in connection with at least one wireless device, the wireless device being operable to communicate with a wireless communication network and including a memory, and being associated with a first player, and in connection with at least one remote network-connected device also linked to the wireless communication network, consisting of a remote wireless device, an artificial intelligence player, or a client computer, the at least one remote network-connected device being associated with at least one second player, the computer program comprising instructions for defining on the wireless device: a client application operable to connect to an intermediary server that acts as an intermediary between the wireless device and the at least one remote network-connected device, the intermediary server being operable to negotiate a plurality of gaming communications created and processed by the client application and a corresponding application linked to each of the at least one remote network-connected device, wherein the client application also defines on the wireless device: a matching facility for matching the first player associated with the at least one second player, in co-operation with the intermediary server; and one or more of the following utilities: a buddy list facility; a chat facility; a contest facility; a ranking facility, and/or an SMS facility; Wherein the matching facility and the one or more utilities of are operable to co-operate with corresponding resources linked to the intermediary computer so as to enable multi-player gaming on the wireless device, as between the first player and the at least one second player.

### BRIEF DESCRIPTION OF THE DRAWINGS

A detailed description of the preferred embodiment(s) is(are) provided herein below by way of example only and with reference to the following drawings, in which:

FIG. 1 is a system architecture diagram generally illustrating the system architecture of the present invention in one aspect thereof.

FIG. 2 is a program resource diagram illustrating the resources of the server application of the present invention in one aspect thereof.

FIG. 3 is a table illustrating generally the gaming communication structure of the present invention, in a particular aspect thereof.

FIG. 4 is a program resource chart generally illustrating the resources of the client application of the present invention in one aspect thereof.

FIG. 5 is a system resource diagram illustrating the resources of the system in one aspect thereof.

FIG. 6 is a still further system resource diagram illustrating the resources system of the present invention in one aspect thereof.

FIG. 7 illustrates the processes as between the client and the server computer of the present invention.

FIG. 8a illustrates the processes as between the client and the server computer involved in multi-player gaming, including matching, by reference to a particular implementation thereof.

FIG. 8b illustrates the processes as between the client and the server computer involved in multi-player gaming, including matching, by reference to another implementation thereof.

FIG. 9 illustrates the resources of the development toolkit of the present invention.

FIG. 10a illustrates the method whereby a game developer creates a multi-player wireless game to the multi-player wireless gaming platform of the present invention.

FIG. 10b illustrates the method whereby a game developer creates a multi-player wireless game to the multi-player wireless gaming platform of the present invention, in another aspect thereof.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

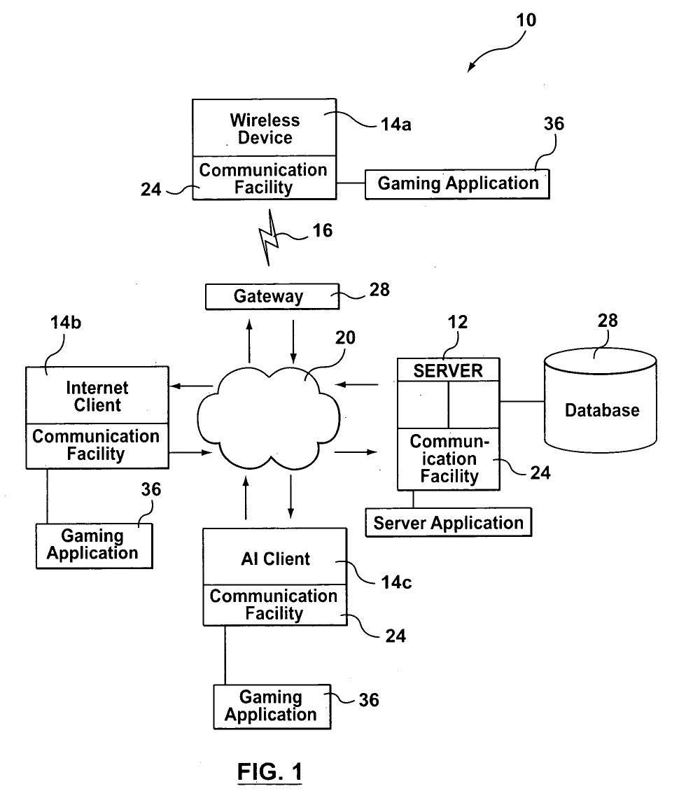

Referring to FIG. 1, there is illustrated a system resource diagram generally illustrating the resources of the system of the present invention in one aspect thereof.

FIG. 1 illustrates that one aspect of the present invention is a multi-player gaming platform 10. The multi-player gaming platform consists generally of a server computer 12 and a plurality of network-connected devices 14a, 14b, 14c. As illustrated in FIG. 1, at least one of such network-connected devices (14a) is a wireless device. The multi-player gaming platform 10 of the present invention and the one or more wireless devices are connected to a wireless network 16. The wireless device 14a is generally connected to the Internet 20 via a wireless gateway 28.

The multi-player gaming platform 10 of the present invention also enables multi-player gaming as between a user associated with a wireless device and a user who is an Internet Client 14b associated with a known computer connected to the Internet 20.

The multi-player gaming platform 10 of the present invention also enables multi-play gaming with an AI player 14c consisting generally of a known computer that includes a known artificial intelligence gaming engine.

As illustrated in FIG. 1, the multi-player gaming system of the present invention includes a server computer 12. The server computer 12 is provided in a manner that is known. It generally includes hardware/software configured to communicate with the wireless network 16, and further to communicate with the Internet 20. This is provided using a known communication facility (not shown). The communication facility is best understood as a series of known communication interfaces that enable communication as between the server computer 12 and the network-connected devices 14a, 14b, 14c (which are collectively referred to as the “Client” or “Clients”), whether via the wireless network 16 or the Internet 20. A known wireless gateway 28 usually enables the interface as between the Internet and the one or more wireless devices 14a.

A representative hardware configuration for the server computer 12 includes a J2EE application server or servlet container such as RESIN™ or TOMCAT™ or IBM WEBSPHERE™.

The connection of the server computer 12 to the Internet 20, is preferably via a permanent Internet connection provided, for example, by a coaxial cable connection or high speed xDSL telephone connection or the like.

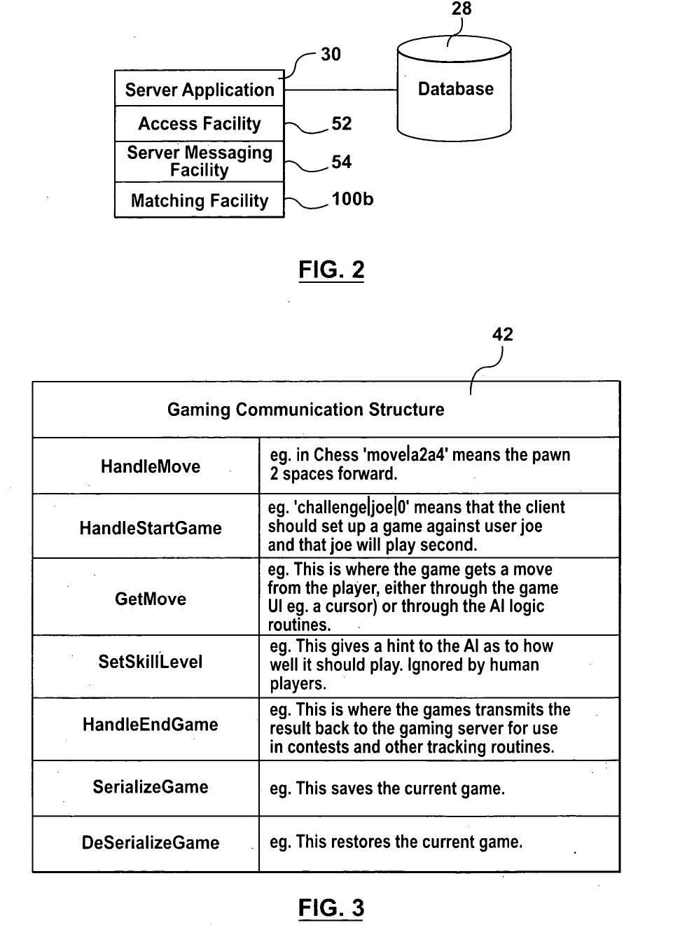

FIG. 2 illustrates generally the principal resources associated with the server computer 12 in one aspect thereof. The server computer 12 is linked to a known database 28. Loaded on the server computer 12 is the server application 30 of the present invention. The server application 30 of the present invention provides the functions particularized below.

One aspect of the server application 30 of the present invention is an access facility 52. The access facility 52 is a known facility for restricting access to the resources of the server computer 12 to users known to the server computer 12. The access facility 52 is linked to the database 28. The database 28 includes an authorized user list with associated passwords corresponding to authorized Clients.

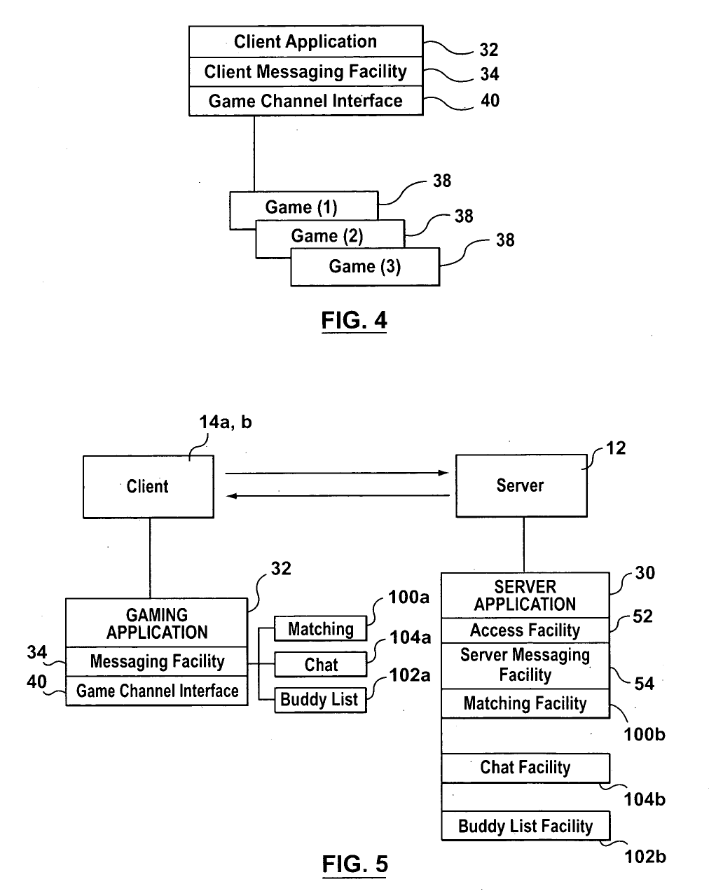

One of the aspects of the invention illustrated below is that the system of the present invention uses a series of data communications, and more specifically gaming communications 42 (illustrated in FIG. 3, and particularized below) having a common structure. In one particular aspect of the present invention, the gaming communication 42 sent by a network-connected device 14 includes the password associated with the player linked to that network-connected device 14. The database 28 also preferably includes a list of registered games with their identifiers.

Therefore the access facility 52 is adapted to query the database 28 in relation to each data communication 42 to ensure that each data communication 42 described (1) is in regard to a registered game; and (2) is from a player who is “signed on”, i.e. s/he has given a recognized username/password via the Client.

Provided that the above requirements are met in relation to the access facility 52, data communications 42 are provided to a server post office facility or server messaging facility 54. The server post office facility or server messaging facility 54 is a utility similar to an email server. The server messaging facility 54 is best understood as a server based messaging utility that is operable to send, receive and manage a plurality of data communications including wireless email, Internet-based communications, text messages and the like. One of the functions of the server messaging facility 54 is to define and manage a series of groups of messages including the various gaming communications described in this disclosure created and processed in the context of multi-player gaming. In one particular implementation of the server messaging facility 54, a server post office facility 54 is provided, which is a utility similar to an email server. The server post office facility 54 is linked to the database 28, and adapted to create a plurality of temporary mailboxes for all logged in users. These temporary mailboxes are used to (1) receive data communications 42 and associate such data communications 42 with a particular multi-player game 38 that is in play between logged in players and to enable the polling of the server computer 12 by the network-connected devices 14 for data communications 42 related to a particular multi-player game.

The server computer 12 is preferably provided in a manner that is scalable to accommodate a growing game user base. This is achieved in a manner that is well known.

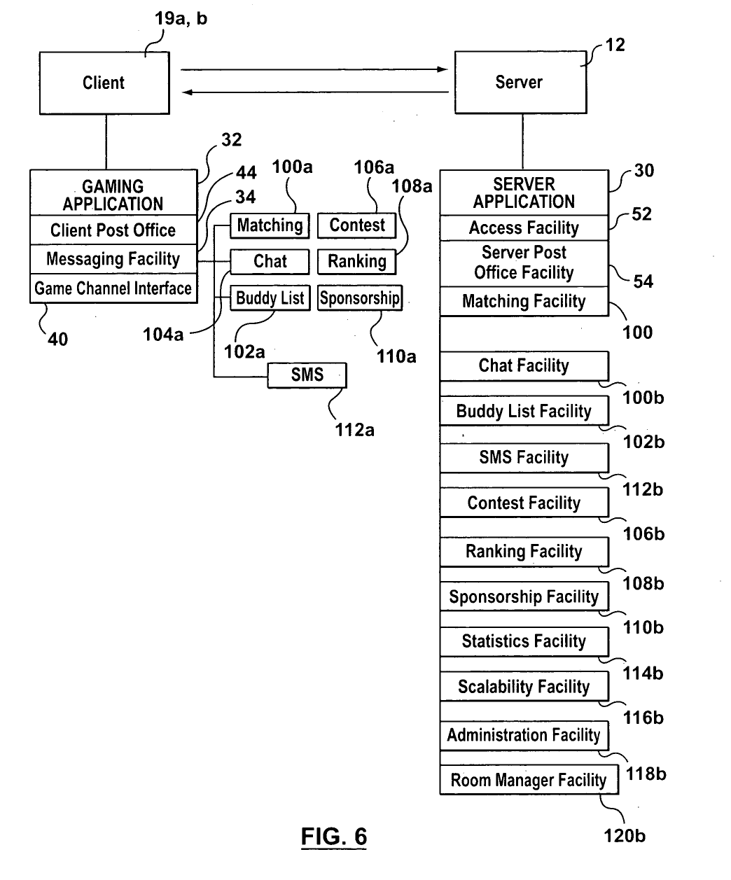

The network-connected devices 14a, 14b, 14c generally include a memory (not shown). One aspect of the present invention is that a client application 32 is loaded on the network-connected device 14, the resources of which client application 32 are generally illustrated in FIG. 4. Where the network-connected device 14 is a wireless device, the client application 32 consists of a wireless application loaded on the wireless device in a manner that is known.

The network-connected device 14a, 14b, 14c will also generally include a known communication facility (not shown). The client communication facility enables communication as between the Client and the server computer 12.

The client application 32 of the present invention consists of a general usage multi-player client application that enables multi-play as described herein. In one particular embodiment of the present invention, the client application 32 as deployed on a wireless device consists of a client application built on an existing wireless communication platform such as J2ME™ (of Sun Microsystems) or BREW™ (of Qualcomm) in a manner that is known.

As generally illustrated in FIG. 4, the client application 32 includes a client messaging facility 34 provided in a manner that is known. The client messaging facility 34 is adapted to send and receive data communications, including the gaming communications 42 particularized below.

The client application 32 is adapted to run one or more wireless games 38 that enable the wireless multi-play as described herein. The wireless games 38 are loaded to the memory of the Client.

Where the Client is a wireless device, the wireless device and the wireless network 16 enable both the downloading of the client application 32 and the various wireless games 38, including over the air, in a manner that is known.

It should be understood that the client application 32, as implemented on a wireless device, does not consist of a thin client but rather a relatively thick client. The thick client preferably includes a relatively rich user interface and access to resources and functions on the wireless device rather than relying on the server computer 12 to provision each processing step to a WAP browser, for example. This further provides relatively fast speed of processing and therefore gaming at the wireless device.

As illustrated in FIG. 4, and mentioned above, one aspect of the client application 32 is a client messaging facility 34. The client messaging facility 34 is a generally a known data communication facility enabled to support, in one particular aspect thereof, the key functions described herein.

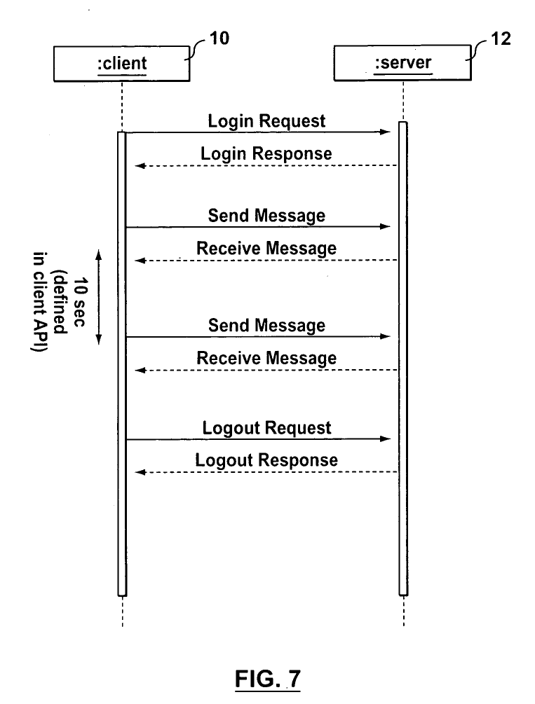

One aspect of the client messaging facility 34 is that it is adapted to filter data communications received by the Client. As explained below, the client application 32 further includes a plurality of facilities that are best understood as software utilities consisting of daemons that sit in the background until in operation a request for the functions that they enable is made, in one particular implementation of the present invention. These facilities are linked to the client application 32, or part thereof. These facilities include, for example, the matching facility 100, buddy list facility 102, chat facility 104, contest facility 106, ranking facility 108, sponsorship facility 110, and SMS facility 112, as illustrated in FIG. 5.

The client messaging facility 34, in a manner that is known, enables a plurality of functions. First, the client messaging facility 34 is adapted to compare a data communication received at the Client to the current state of the client application 32. Second, the client messaging facility 34 determines if the data communication relates to a particular facility described. Third, the client messaging facility 34 passes on the particular data communication to the particular facility to which it relates. Fourth, the client messaging facility 34 is adapted to ignore the data communications that do not appear to relate to the operation of a particular facility described above that is linked to, or forms part of the client application 32, for example if the data communication is a mistake, e.g. it has been sent to the wrong address. This particular aspect of the client messaging facility 34 reduces the potential impact of errors on the operation of the client application 32 overall.

An illustration of the operation of the client messaging facility 34 consists of the Client receiving a data communication that is a gaming communication 42, for example, a HANDLEMOVE as described below. The nature of this particular data communication is recognized by the client messaging facility 34 whereby it is passed on to the game model facility 40 for processing.

Another aspect of the client application 32 is the client post office facility 44, as illustrated in FIG. 3. The client post office facility 44 is best understood as a known passive message store for retaining data communications for processing by the client application 32 as described herein.

The client post office facility 44 and client messaging facility 34 co-operate to (1) assemble data communications, including gaming communications 42; (2) send data communications including gaming communications 42 to the server computer 12; (3) poll the server computer 12 for data communications including gaming communications 42; (4) if a gaming communication 42 consisting of a move is received from the server computer 12, the client post office facility 44 and client messaging facility 34 assemble a further gaming communication 42 identifying the other players in a particular multi-play game for dispatch to such other players via the server computer 12; and (5) make gaming communications 42 available to the game model facility 40 for interpretation thereof in order to process the gaming communications 42 as input for multi-player gaming.

As illustrated in FIG. 5, another aspect of the client application 32 is the game model facility 40. The game model facility 40 is best understood as a programmatic interface that abstracts the steps of each wireless game 38 into a data communication, or gaming communication 42, having a common structure. The game model facility 40 is a common entry point for gaming communications 42 for processing regardless of the specific game 38 to which they relate.

This common structure of the gaming communications 42, in accordance with one very particular aspect of the present invention, is generally as follows:
<recipient>|<command>|<data>

FIG. 3 includes a list of representative gaming communications 42. The common structure facilitates the relaying of messages by the server computer 12, and interpretation thereof by the client application 32. The common structure shown illustrates the structure of data communications generally in accordance with the present invention, not just gaming communications.

Another aspect of the game model facility 40 is that it interprets incoming gaming communications 42 received from the server computer 12 as explained below such that the game model facility 40 enables the client application 32 to process multi-player games based on the input of such data communications 42.

In this regard, one particular aspect of the game model facility 40 is that it is adapted to filter the data communications passed on to the game model facility 40 by the client messaging facility 34 and handle only those data communications that are recognized gaming communications 42.

A still other particular aspect of the game model facility 40 is that it processes recognized gaming communications 42 whether they are from an AI player, another Wireless player or an interactive player.

One of the advantages of the present invention is that the use of the game model facility 40 loaded on the Client that processes gaming communications 42 having a common structure, it is relatively easy deploy new games with little or no change to the gaming platform 10 overall. This is because the functions of the multi-player gaming platform 10 of the present invention can be extended, maintained, updated or otherwise modified without any changes being required to the game itself. This is in turn reduces the investment of time and other resources required to development multi-player games enabling play from at least one wireless device. This also reduces the barriers to entry to game developers and therefore encourages the rapid expansion of game titles available on the multi-player gaming platform 10. It should be understood that a particular advantage of the present invention is that the operator of the server computer addresses threading and network issues related to the deployment of multi-player games.

In another aspect of the client application 32, and also of the method of the present invention, the client application 32 enables the following steps: (1) the client application 32 determines how many players are involved in a wireless game 38 and their identities (e.g. network username); (2) the client application 32 sends a gaming communication 42 consisting of a move to the server computer 12; (3) if a gaming communication 42 consists of a move, the server application 32 sends the move as a gaming communication 42 to the other players over the wireless network 16 or Internet 20. The other players are selected as detailed below.

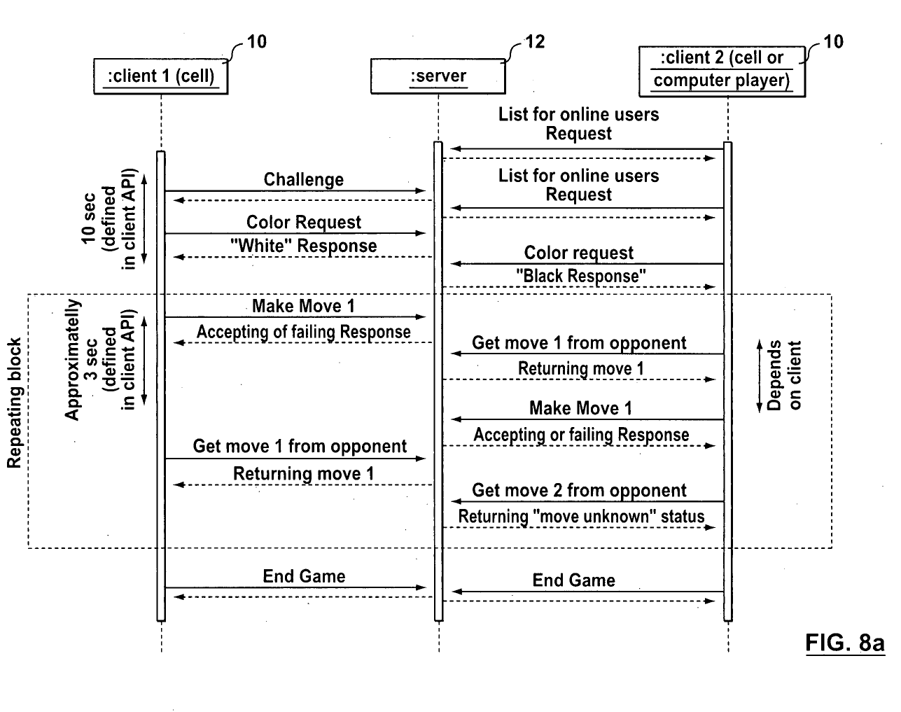

The server application 30 also includes a series of utilities linked to the operation of the server, including the statistics facility 114, scalability facility 116, logging facility 118 and room manager facility 120 as illustrated in represented in FIG. 6. The processes enabled by these server side facilities are particularized below.

On the Client side, the various facilities linked to the client application 32 described, are best understood as DAEMON applications provided in a manner that is known, as mentioned above.

Another aspect of the client application 32 of the present invention is that it provides a plurality of gaming interfaces for soliciting game-related input from the Client, in providing game-related input. These gaming interfaces are provided in a manner that is known. The gaming interfaces provided in accordance with the present invention are generally relatively abstracted. This enables new games to be written to the gaming platform 10 of the present invention relatively quickly, as further particularized below.

Representative gaming interfaces include:

HANDLESTARTOFGAME is generally a standard user interface that resolves start of game issues including (1) soliciting the player to initialize the board interface provided by the client application 32, (2) whether s/he plays first or second (depending on the game) and so on.

SETSKILL LEVEL is an interface that solicits input from the player as to the skill level at which the player decides the AI Player to play. In another particular embodiment of the present invention, the interface enables the player to determine a historical skill level to be associated with matched “live” players in accordance with the matching process described below.

GETMOVE is a standard interface whereby the player is asked for his/her move, e.g. in chess the player provides input that results in the creation of the string ‘move|a3a4’.

HANDLEMOVE is a standard interface that requests the player to handle a game move such as for example in chess the move ‘move|a3a4’, i.e. move your pawn up one space.

HANDLEENDOFGAME is an interface that pops us once a game is over, displays the outcome, and communicates back to the server computer 12 for the purpose of network tracking, contests and so on.

SERIALIZE/DESERIALIZE GAME is an interface that permits the player to save and load a particular game state. The game state can be reloaded at a later time in which case this interface enables a player to send an AUTOMATCH request (detailed below) to resume the particular game.

The gaming communications 42 as between Clients and the server computer 12 generally occur, in one particular aspect of the present invention, as HTTP request-response pairs, provided in a manner that is known.

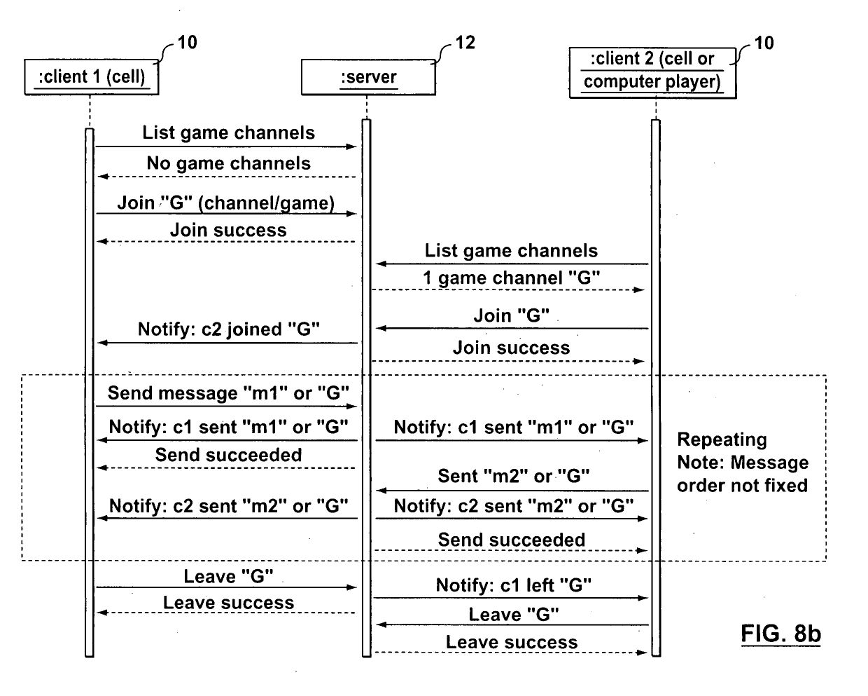

In accordance with one particular aspect of the method and computer program of the present invention, FIG. 7 illustrates the processes as between the Client and server computer 12 of the present invention. A login request is sent by the Client to the server computer 12. The login request contains the user ID and password. The server computer 12 sends in response an HTTP response indicating success or failure. When the Client is logged in to the server computer 12 but not playing a game, it will poll the server computer 12 every 45 seconds for a listing of players logged in to the server computer 12, in one particular implementation of the present invention. The Client logs out of the server computer 12 with a logout request. The server computer 12 confirms the logout in an HTTP response.

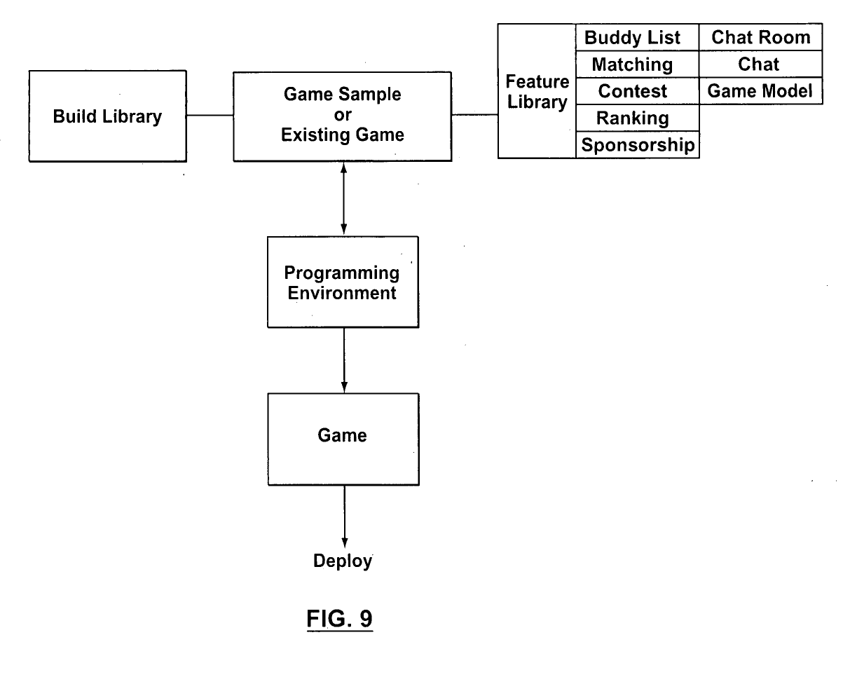

In accordance with yet another aspect of the method and computer program of the present invention, FIG. 8 illustrates the processes as between the Client and the server computer 12 involved in multi-player gaming, including matching, by reference to a particular implementation. The scenario illustrated involves two players only, namely Client1 and Client 2.

These processes are enabled by the matching facility 100 linked to the client application 32, and also associated facilities described above including the client post office facility 44 and the client messaging facility 34. The processes described below depend on the operation of the server post office facility 54 which acts a list of “mailboxes” stored to the database 28. The various Clients involved in multi-player gaming in accordance with the present invention routinely poll the mailboxes created by the server post office facility 54 to pick up new messages that relate to them. In one particular aspect of the server post office facility 54, once a particular message has been picked up, it is deleted from the database 28.

Accordingly, the following processes are involved in matching players in accordance with the multi-player gaming method of the present invention:
Client1 challenges Client2 to a game. This is accomplished by Client1 sending a challenge request to the server computer 12. The challenge request is one particular gaming communication 42.
The server computer 12 acknowledges the challenge request. This acknowledgment does not yet indicate whether Client2 has accepted the challenge or not.
Client1 sends a request to the server computer 12 to verify whether client2 has accepted the challenge or not. This request is repeated within a predetermined interval (e.g. every 15 seconds) until Client2 either accepts or rejects the challenge. It should be understood that this very particular aspect of the present invention contributes to minimize network errors and down time that might interfere with multi-player gaming.
The next time Client2 polls the server computer 12, as indicated above, Client2 will be informed of the challenge from Client1.
Client2 will send a request to the server computer 12 indicating that the challenge is accepted (if this is the case). The server computer 12 will acknowledge this request with a response.
As in the case of Client1, Client2 is required to send a request to the server computer 12 asking for a color.

Once the matching of the various players has occurred, the multi-player gaming method of the present invention is also illustrated having regard to FIG. 8, and the following description of the related processes enables by the facilities described:
The client application 30 knows which of the players has to make the first move. The moves are solicited from the players by the interfaces described above.
Once the move is made, the Client will send the move as a request to the server computer 12. An acknowledgment will be sent back to the Client by the server computer 12.
While it is the opponent's turn to move, the Client will poll the server computer 12 within predetermined intervals (e.g. every 5 seconds) to receive the opponent's next move. Client sends a response either with the move or indicating that the Client has not yet moved.
In the example illustrated in FIG. 8, Client1 is white and Client2 is black (the first player is generally white and the second player is generally black, in one particular implementation). Because white has the first move, Client1 moves first, and Client2 receives the move on its next request to the server computer 12. Client2 then makes its first move and Client1 receives this move on its next request to the server computer 12. If Client1 takes a long time to make its second move such that Client2 will continue to make requests to the server computer 12 which will result in the server computer 12 sending a “MOVE UNKNOWN” response.
This continues until a winning move is made, in which the client application 32 on each Client (based on operation of the game model facility 40) will know that the game has ended and will send a response to this effect to the server computer 12.

It is important to highlight that in the present invention, communication is facilitated by the server application 30 that enables multi-player gaming, but in a manner that the nature of the game is transparent. The processes that differentiate one game from another are handled on the Client side by the game model facility 40.

There are a number of benefits to the foregoing process. For example, unnecessary waiting time at either Client is avoided in that if Client1 continues to be logged on, but has not made a responding move yet, Client2 continues to receive responses from the server computer 12 to the effect that Client1 is logged on, but has not yet made a move. If a player involved in multi-player gaming logs out during play, then the server computer 12 will notify each of the other Clients in which case in most games 38 the game will continue minus the logged out player. Generally in this case, a message is displayed saying “OPPONENT ABORTED GAME” or equivalent, and the game ends.

In another particular aspect of the present invention, if Client1 takes a long time to make a request after it has logged on, the server computer 12 will generally log out the associated network-connected device 14.

Now referring to FIGS. 5 and 6, one aspect of the system of the present invention is a system architecture whereby the server application 30 and the client application 32 generally include corresponding resources such as the matching facility 100, buddy list facility 102, chat facility 104, contest facility 106, ranking facility 108, sponsorship facility 110 and SMS facility 112. These facilities linked generally linked to the server application 30 and the client application 32 enable communication as between the various Clients for the purpose of enabling the functions of these facilities, as particularized below.

It should be understood that at the Client side, particular facilities can be downloaded (for example by air) on an as needed basis as particular functions are required by the Client user.

In relation to these facilities linked to the client application 30, these facilities generally act as daemons operating in the background, until their resources are requested from the client application 32 by the user. The various daemons in response to such a request enable the client application 32 and server application 30 to cooperate to process the requests/responses required to enable those functions.

The facilities on the Client side bear “a” identifiers in their assigned numbers, the corresponding facilities on the server computer 12 side bear “b” identifiers. References to the functions provided on the Client and server side together are generally referred to as “ab”.

The description below illustrates the functions/operations enabled by the facilities described. These functions are generally enabled by requests/responses exchanged as between the Client and server computer 12 by operation of the server post office facility 54 and the client post office facility 44 (in cooperation with the other utilities described above to which they are linked, as illustrated in FIG. 6, 7). The details of the related processes (including particular sequences of requests/responses) are not fully detailed in regard to these facilities, but operate in a manner that is analogous to the matching process described above.

Another aspect of the matching facility 110ab not described above is that it enables a process whereby every player making a request to play will be matched whether the challenge is responded to by another player or not. The matching facility 100b maintains a hash, in a manner that is known, of all requests made by players by game, skill level, player type and player type requested. The matching facility 100b is adapted to match the request against the contents of the hash and communicate the match results as move request send by the players selected by this process. If no matching player is found in the hatch, the matching facility 100b is adapted to match the player with an AI player, in one particular embodiment of the present invention.

The buddy list facility 102a is best understood as a daemon on the Client side that stores the contact data for a list of buddies to the memory associated with the network-connected device 14. Another aspect of the buddy list facility 102a is that it cooperates with the client messaging facility 34 to send requests to the server computer 12 for the buddy list facility 102b to check to see the status of the one or more individuals listed on the buddy list and report back to the Client as to whether such individuals are “online” or “offline”.

The chat facility 104ab is best understood as a facility that enables the data communications exchanged between the Client and the server computer 12 to include simple chat-type text messages, with the normal functions generally associated with chat in a manner that is known. On the server computer 12 side this happens as a matter of course as text messages are distributed in accordance with the operation of the server post office facility 54 much as any other type of message. On the client application 32 side, the chat facility 104a cooperates with the client application 32 to display text messages as “CHAT” in a format that is well known as they are received at the wireless device 104a.

A further aspect of the present invention is the room manager facility 120 that cooperates with the chat facility 104ab. The room manager facility is a known facility on the server computer 12 side that keeps an internal list of chat rooms. These chat rooms are initially populated from the database 28 (and configurable over the web). Authorized users can request to see a list of rooms, join a room and then chat in the room, in co-operation with the chat facility 104ab. The manager (administrator of server computer 12) is responsible for broadcasting a message from any one user to all other users in a room. This is enabled by the data communications described above. This aspect of the present invention can also be associated with a website using JSP, in a manner that is known. One very particular aspect of the present invention is that both a Wireless Device 14a and an Internet Client 14b can plug into the computer architecture described to use the same chat rooms by operation of the room manager facility 114.

The contest facility 106a on the Client side is best understood as an aspect of the client application 30 that enables the Client to select to participate in a contest that is linked with multi-player gaming of a particular game 38. More significantly, on the server computer 12 side, the contest facility 106b enables the operator of the server computer 12 to set up contests, and the parameters thereof. The contest facility is linked to the statistics facility 114 referenced below.

The ranking facility 108a on the Client side is best understood as an aspect of the client application 30 whereby once a game has ended, the players communicate the results to the server computer 12 along with whom they were playing. One aspect of the ranking facility 108b on the server side is that it maintains a file on the database 28 that includes the rankings of each authorized user associated with the server computer 12. The ranking facility 108b is responsive to the results provided by the client application 30 described above to alter the ranking files of the players involved in the game based on a predetermined formula to reflect the results of new recorded game. The ranking facility 108b is further adapted to add ranking data to challenge requests referred to above to ensure that players know the ranking of potential opponents. This is to avoid players taking on opponents that are ranked higher or lower than they want.

The sponsorship facility 110a is best understood on the Client side as an aspect of the client application 32 whereby graphic material, text and the like can be displayed to the gaming interface (not shown) of the network-connected device 14 to promote a particular contest. More importantly, on the server computer 12 side, the sponsorship facility 110b is best understood as a utility that enables the operator of the server computer 12 to (1) specify a particular sponsor for a specific game for a period of time; create and load marketing materials such as splash screens, logos on the gaming interface and the like.

The server application 30 further includes a statistics facility 114 that is a known utility that tracks the activities of the various authorized users. The function of the statistics facility 114 is to track what contests players have signed up for, what games have been played, how many entries in each contest each person has, what phone they used, what network (AT&T, Telus etc.). The information is stored to the database 28. The statistics facility 114 cooperates with the contest facility 106b and the sponsorship facility 110b to provide the functionality described.

The server application 30 also includes a known SMS facility 112b that enables SMSing between users who are offline. The SMS facility 112ab is a known utility, implemented in a manner that is known. It is best understood as a helper daemon on the Client side. On the server side, in one particular implementation of the present invention, the SMS facility 112b consists of a known SMS server connected to the server computer 12.

In one particular aspect of the present invention, the server application 30 is provided with a scalability facility 116. This facility is best understood as a series of scalability features associated with the server computer 12 in a manner that is known. One particular aspect of such a feature is to enable the server post office facility 54 to be dynamically expanded as the need for a total number of mailboxes described expands as the usage of the server computer 12 increases. For example, in one aspect of the present invention, the server post office facility 54 is implemented using a tool such as the JGROUPS™ open source library, which enables the various mailboxes created to span multiple computers thereby providing a resources scalable across a plurality of computers, implemented in a manner that is known.

Another aspect of the present invention is the statistics facility 114. This is a known facility that collects historical data and further provides access to one or more interfaces for generating, accessing, viewing, printing, storing, and sending reports based on such data. The historical data relates to, for example, usage of the multi-player gaming platform described. The statistics facility 114 enables generation of billing information, electronic invoicing, e-commerce facility for pay as you go charge-out of multi-player gaming and so on.

Yet another aspect of the present invention is administration facility 118. This is a known facility that enables a series of functions such as the administration of an authorized user list; management of various installations related to production, development, testing, debugging; management of log-in parameters; turnaround times (e.g. average message, current message); memory management and so on.

A still other aspect of the invention, is a method whereby games for play between a plurality of users, at least one of which is associated with a wireless device, can be written to the multi-player gaming platform described above with relative ease and speed.

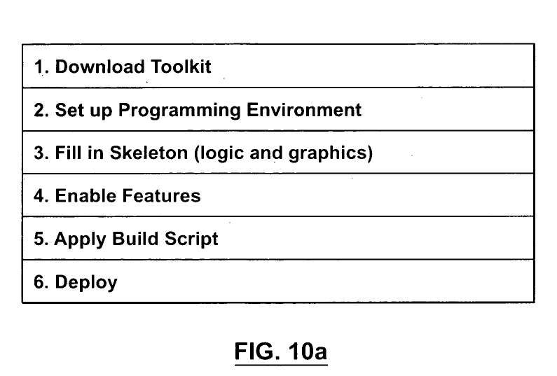

In one particular aspect of this method, this involves making available to a plurality of game developers what is best understood as a development toolkit. A number of aspects of this toolkit are illustrated in FIG. 9.

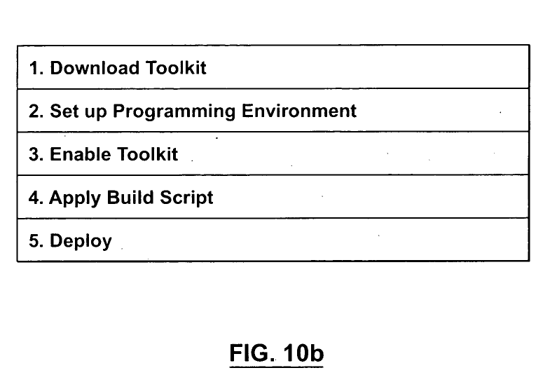

As illustrated in FIG. 10, the method described involves the following:
(a) Downloading the toolkit.
(b) Setting up the programming environment 118 illustrated in FIG. 9. This includes, for example, in a particular implementation, the set-up of the compiler, basic JAVA tools, interface paint tools, windowing libraries and so on.
(c) Filling in the game skeleton 120 with logic and graphics. The game skeleton 120 includes the basic routines and interfaces required to play any multi-player wireless game, including coding to enable different players to interface with the game (AI, Interactive and Meta Provider). The various steps of the game are then implemented based on the logic. The logic is based on the basic elements described above such as handleMOVE, getMOVE, serializeGAME and so on. Specific coding for particular routines is obtained from the build library 124 and brought into the game skeleton 120.
(d) Enabling features from the feature library 122. In one particular embodiment of the present invention, this enabling of the features occurs automatically. This involves linking the game being created with the functions of particular facilities described above and their functions, e.g. the buddy list facility 102ab to enable maintenance of a buddy list of preferred other players in regard to a particular game. The present invention enables “plug and play” deployment of these facilities and the functions that they enable.
(e) Apply the build scripts. The build scripts are contained in the build library 124. The application of the build scripts to the game skeleton 120 and selected features results in the creation of a plurality of the multi-player wireless game. In one particular implementation of the present invention, this game consists of a series of JAVA source files.
(f) Deploy the multi-player wireless game.

One of the advantages of the method of the present invention, is that it enables an easy method to plug in features supported by the multi-player gaming platform described, without the need for extensive testing or debugging of new games created based on this method. This is because creation of a game as described herein results in the automatic application of programming standards subsumed in the toolkit (including its elements). The deployment of a multi-player wireless game to various wireless networks, interfaces supported by particular wireless devices and so on can be time consuming. The present invention enables the developer to focus more on game development and less on these deployment issues.

The toolkit overall is best understood as a known jar file or equivalent. The file contains various programmatic routines and interfaces to produce a multi-player wireless game deployed to the multi-player gaming platform described. The jar file notably includes the programming environment 118 which is a known execution framework that enables the selection of routines and interfaces to the execution framework, which enables the compilation of deployable programs, namely the multi-player games discussed herein.

The jar file enables the distribution of tools for creating an executable program without the various source files.

The jar file is usually obtained in a compressed format, for example as a zip file.

A still other particular aspect of the present invention, is the order in which a new game is written to the multi-player gaming platform described. It has been found that programming the game logic correctly is a relatively challenging aspect of creating games as described. This is easier where (1) the game board is created and debugged; and (2) then the game logic is implemented.

With greater particularity, this can be achieved in accordance with the following method which is yet another particular aspect of the present invention that illustrates the invention having regard to implementation of different types of players in creation of a multi-player wireless game:
(a) Create a basic test platform for an AI player. This involves selection of the AI player functions of a game skeleton 120. These functions either do not include specific functions, or these are cleared out. This now provides the “AI PLAYER”.
(b) Create a basic test platform for a player using a wireless device. This involves selection of the interactive player functions of a game skeleton 120. These functions either do not include specific interactive player functions, or these are cleared out. This provides the key programming interfaces and routines for an “INTERACTIVE PLAYER”.
(c) Code a representation of the playing board in a separate object, and note that the Al and wireless device client will use this object to represent the game board. In one still more particular implementation of the present invention, known programming guidelines are used to ensure adherence to the J2ME platform.
(d) For both the AI PLAYER and the INTERACTIVE PLAYER, implement the handleStartGame routine that means that the player number is passed to each type of player such that each player knows, for example, whether they are “WHITE” or “BLACK”.
(e) The rendering of the game board is then tested. This involves compiling both the AI PLAYER and the INTERACTIVE PLAYER. This is specifically accomplished by launching the jar components for the INTERACTIVE PLAYER in a J2ME emulator, and the jar components of the AI PLAYER on the command line of a desktop. In the emulator, the “PLAY COMPUTER” option is engaged. This will enable the wireless device to find the AI PLAYER, start the game, and display the rendering of the game board previously provided. The rendering is debugged, if necessary.

In one particular aspect of the present invention, it should be understood that some routines or interfaces described may be displayed when selected in whole code format, whereas others for the sake of protection of key confidential information such as critical interfaces may be kept hidden and shown, for example, as a representative identifier or icon only.

It should be understood, in relation to the methods or processes described herein, that the order of one or more of the steps described can be changed without affecting the essential aspects of the method described.

References to “multi-player wireless games” herein refer to a multi-player game that enables at least one user associated with a wireless device to play the game with other players who may be one or more users associated with a wireless device, one or more AI clients, or one or more Internet clients.

Numerous extensions or modifications of the present invention are possible. For example, added features can be provided to the system of the present invention, for the purpose of enhanced sponsorship functionality. The multi-player gaming portal described can be modified to link with the computer systems associated with third party gaming portals. Numerous other processes can be added to operation of the system of the present invention, including for example enhanced matching of players. For example, a player can be matched with a computer opponent after waiting for a response to a challenge for so long.

1. A method for providing multi-player gaming on a wireless device comprising the steps of:
(a) Providing on the wireless device a wireless application that enables a user associated with the wireless device to send and receive a plurality of communications defining one or more steps involved in playing a game to at least one remote network-connected device consisting of at least one of a remote wireless device, an artificial intelligence player and/or a remote client computer, via an intermediary server, the at least one remote network-connected device being linked to a wireless application generally corresponding to the wireless application;
(b) Sending a request for multi-player gaming to the intermediary server from the wireless device;
(c) In response to (b), matching the user associated with the wireless device with at least one other player associated with the at least one remote network-connected device, by operation of a matching facility linked to the intermediary server;
(d) Activating a multi-player game linked to the wireless application, thereby enabling the user to make one or more initial moves by providing input to the wireless application, thereby engaging the wireless application to assemble a gaming communication, and deliver the gaming communication to the intermediary server; and
(e) Each of the user and the at least one other player thereafter polling the intermediary server for a plurality of gaming communications consisting of moves from the at least one network-connected device, said gaming communications being interpreted by the wireless application in accordance with the multi-player game, and in response to such game communications, each of the user and the at least one other player making further moves by providing input to the wireless application or the corresponding wireless application, thereby engaging the wireless application or the corresponding wireless application to assemble further gaming communications, and deliver the further gaming communications to the intermediary server, until an end game defined by the multi-player game is achieved.

2. The method claimed in claim 1, comprising the further steps of:
(a) assembling each gaming communication to identify the player associated with the gaming communication; and
(b) by operation of a server application linked to the intermediary server, identifying communications received by the intermediary server consisting of gaming communications associated with the multi-player game, and storing such gaming communications to a database linked to the intermediary server, such that the server application is responsive to one or more polling requests from a requesting wireless device or remote network-connected device to access such gaming communications from the other of such wireless device or remote network-connected device and forward such gaming communications to the requesting wireless device or remote network-connected device.

3. The method claimed in claim 2, comprising the further step of defining on the intermediary server a list of authorized passwords identifying users authorized to access the resources of the intermediary servers by operation of an access facility linked to the intermediary server, whereby the intermediary server processes gaming communications that include an authorized password.

4. The method claimed in claim 1, comprising the further step of interpreting gaming communications received at each wireless device or remote network-connected device by reference to game logic defined by the multi-player game, by operation of the wireless application or the corresponding wireless application.

5. The method claimed in claim 1, whereby the user is matched with the at least one other player by:
(a) The user initiating the wireless application to assemble a challenge request, which is sent to the intermediary server by operation of the wireless application;
(b) The intermediary server sending the challenge request to the at least one other player;
(c) The intermediary server acknowledging the challenge request to the wireless device associated with the user;
(d) The user optionally sending a request to the intermediary server to verify whether the at least one other player has accepted the challenge or not within a defined time interval; and
(e) The at least one other player accepting the challenge, whereby the user and the at least one other player are matched, by operation of the server application.

6. The method claimed in claim 5, whereby when a player logs out during play, the corresponding wireless application linked to the network-connected device associated with that player notifies the intermediary server, and the intermediary server notifies each of the remaining players.

7. A system for providing multi-player gaming on a wireless device comprising:
(a) At least one wireless device being linked to a client application and to a memory, and associated with a first player;
(b) At least one remote network-connected device, consisting of a remote wireless device, an artificial intelligence player, or a client computer, the at least one remote network-connected device being associated with at least one second player, the at least one remote network-connected device also being linked to a client application generally corresponding to the client application, and further linked to a memory;
(c) An intermediary server operable to connect to each of the at least one wireless device and the at least one remote network-connected device, the intermediary server client computer and the wireless device, the intermediary server being linked to a server application and a server database;
Wherein the client application enables the first player or at least one second player to send and receive a plurality of communications defining one or more steps involved in playing a game to and from the intermediary server, the intermediary server acting as a intermediary for gaming communications as between the at least one wireless device and the at least one remote network-connected device;
Wherein the client application is operable to send a request for multi-player gaming to the intermediary server from the at least one wireless device, and in response the server application is operable to match the first player with the at least one second player, by operation of a matching facility linked to the intermediary server;
Wherein the client application and the corresponding client application are linked to a gaming utility that includes at least one multi-player game that enables the first player and the at least one second player to make one or more moves, and in response to such moves the client application being operable to assemble a corresponding one or more gaming communications for delivery to the intermediary server; and
Wherein the client application is further operable to poll the intermediary server for gaming communications received from the other matched players, namely the other of the first player or the at least one second player, and to interpret the polled gaming communications in accordance with the multi-player game, and in response to such game communications, each of the first player and the at least one second player making further moves by providing input to the gaming utility, thereby engaging the client application to assemble further gaming communications, and deliver the further gaming communications to the intermediary server, until an end game defined by the multi-player game is achieved.

8. The system as claimed in claim 7, wherein the matching facility is operable to:
(a) In response to the first player initiating the client application to assemble a challenge request, which is sent to the intermediary server by operation of the client application associated with the first player, the intermediary server sends the challenge request to the at least one second player;
(b) Acknowledge the challenge request to the wireless device associated with the first player;
(c) The first player optionally sending a request to the intermediary server to verify whether the at least one second player has accepted the challenge or not within a defined time interval;
(d) Upon the at least one second player accepting the challenge, the matching facility matching the first player and the at least one second player and establishing on the server database a play session that recognizes each of the matched first player and the at least one second player.

9. The system as claimed in claim 7, wherein the client application is adapted to filter communications received at the wireless device so as to determine which of such communications consists of a gaming communication, and provide such gaming communication to the gaming utility for processing in accordance with the game logic of the then current multi-player game.

10. The system as claimed in claim 7, wherein the gaming utility is linked to a plurality of utilities including one or more of a client matching facility, a client buddy list facility, client chat, facility, client contest facility, client ranking facility, and/or client SMS facility, and the client application is further operable to:
(a) Compare a gaming communication to the current state of the wireless device or the remote network-connected device;
(b) Determine if the gaming communication relates to a particular one of the plurality of utilities, and if so passes the gaming communication to such particular one of the plurality of utilities for processing; and
(c) Ignore a data communication that does not appear to relate to the operation of the gaming utility, or any one or more of the plurality of utilities.

11. The system as claimed in claim 10, wherein the gaming utility is programmed such that the first player makes the first move by issuing a challenge request.

12. The system claimed in claim 10, wherein the server application includes resources corresponding to each of the plurality of utilities consisting of one or more of a server matching facility, a server buddy list facility, server chat facility, server contest facility, server ranking facility and/or a server SMS facility, wherein the corresponding facilities at each of the server computer and the wireless device and/or the at least one remote network-connected device are operable to cooperate to process the requests/responses required to enable the functions thereof.

13. The system claimed in claim 12, wherein:
(a) The client buddy facility is operable to store to the memory contact data for a list of gaming contacts, and the client buddy facility and the server buddy facility cooperate to enable the client application to send a request to the intermediary server to check the status of one or more players indicated in the list of gaming contacts;
(b) The client chat facility enables the user thereof to create chat text messages and display chat text messages, which are delivered as between players by cooperation between the client chat facility and the server chat facility; the server chat facility also including a room manager facility that cooperates with the client chat facility associated with the wireless device and the at least one remote network-connected device to create and manage a plurality of chat rooms;
(c) The server contest facility enables the operator of the server computer to create and manage a series of contests in connection with one or more multi-player games, wherein the contests are implemented by cooperation between the server contest facility and the client contest facility;
(d) The client ranking facility is operable to communicate the results of a particular multi-player game to the server computer for storage to a ranking list established on the server database by the server ranking facility, the server ranking facility being operable to update the ranking list based on further results provided in subsequent multi-player games, providing ranking information to players on other players, and/or co-operating with the matching facility to match players with other players with similar ranking information; and
(e) The client SMS facility enables the user thereof to create SMS messages, which are delivered as between players by cooperation between the client SMS facility and the server SMS facility.

14. A method of creating multi-player games operable as between a wireless device and at least one other remote network-connected device comprising the steps of:
(a) Providing a server computer linked to a server application and a client application operable on a wireless device, the server application and the client application being operably linked to provide a multi-player gaming platform, the multi-player gaming platform consisting of a plurality of utilities that enable multi-player gaming, such utilities including a matching utility for matching a first player associated with a wireless device with at least one second player associated with another wireless device, an artificial intelligence player or a client computer, and also one or more of the following utilities:
(i) a buddy list facility;
(ii) a chat facility;
(iii) a contest facility;
(iv) a ranking facility, and/or
(v) an SMS facility;
(b) Providing a toolkit that enables the development and deployment of one or more multi-player games, whereby the toolkit includes at least one game interface that enables game content including one or more of graphics, text, and game logic to be created that is operable to interface with the multi-player gaming platform, thereby enabling the creation of a multi-player game that interoperates with the matching utilities and one or more of the buddy list facility, the chat facility, the contest facility, the ranking facility and/or the SMS facility; and
(c) Creating one or more multi-player games to the at least one game interface.

15. The method of claim 14, comprising the further step of deploying the at least one multi-player game to the multi-player gaming platform and thereby activating a plurality of functions linked to the multi-player gaming platform by operation of the matching facility and one or more of the following utilities:
(a) a buddy list facility;
(b) a chat facility;
(c) a contest facility;
(d) a ranking facility, and/or
(e) an SMS facility.

16. A computer program for enabling multi-player gaming in connection with at least one wireless device, the wireless device being operable to communicate with a wireless communication network and including a memory, and being associated with a first player, and in connection with at least one remote network-connected device also linked to the wireless communication network, consisting of a remote wireless device, an artificial intelligence player, or a client computer, the at least one remote network-connected device being associated with at least one second player, the computer program comprising instructions for defining on the wireless device:
(a) A client application operable to connect to an intermediary server that acts as an intermediary between the wireless device and the at least one remote network-connected device, the intermediary server being operable to negotiate a plurality of gaming communications created and processed by the client application and a corresponding application linked to each of the at least one remote network-connected device, wherein the client application also defines on the wireless device:
(i) a matching facility for matching the first player associated with the at least one second player, in co-operation with the intermediary server; and
(ii) one or more of the following utilities:
(A) a buddy list facility;
(B) a chat facility;
(C) a contest facility;
(D) a ranking facility, and/or
(E) an SMS facility;
Wherein the matching facility and the one or more utilities of (ii) are operable to co-operate with corresponding resources linked to the intermediary computer so as to enable multi-player gaming on the wireless device, as between the first player and the at least one second player.

17. The computer program claimed in claim 16, wherein the client application enables the first player to send and receive a plurality of communications defining one or more steps involved in playing a multi-player game stored to the memory, to and from the intermediary server, including communications from the at least one second player via the intermediary server.

18. The computer program claimed in claim 17, wherein the client application is operable to send a request for multi-player gaming to the intermediary server from the wireless device, and in response intermediary server is operable to match the first player with the at least one second player, by operation of a matching facility linked to the intermediary server that interoperates with the matching facility linked to the wireless device.

19. The computer program claimed in claim 18, wherein the client application includes a gaming utility that is operable to process the multi-player game thereby enabling the first player to provide user input that initiates one or more game moves, and in response to such moves the client application assembling a corresponding one or more gaming communications for delivery to the intermediary server, as defined by game logic defined for the particular multi-player game by the gaming utility.

20. The computer program claimed in claim 19, wherein the client application is further operable to poll the intermediary server for gaming communications received from the other matched players, namely the at least one second player, and to interpret the polled gaming communications in accordance with the multi-player game, and in response to such game communications, gaming utility being operable to receive user input from the first player to make further moves and assemble further corresponding gaming communications, and deliver the further corresponding gaming communications to the intermediary server, until an end game defined by the multi-player game is achieved.

21. The computer program claimed in claim 16, wherein the client application is further operable to provide to the intermediary server login data that is recognized by a user access facility linked to the intermediary server, such that the provision of the login data enables the first player to access the resources of the intermediary server and also to initiate the intermediary server to retrieve gaming communications stored to a server database linked to the intermediary server and linked to an in-play game associated with the first player, and send such gaming communications to the wireless device.

22. The computer program claimed in claim 16, wherein the corresponding resources of the intermediary computer consist of a server buddy facility, a server chat facility, a server contest facility, a server ranking facility and/or a server SMS facility, and wherein:
(a) The client buddy facility is operable to store to the memory contact data for a list of gaming contacts, and the client buddy facility and the server buddy facility cooperate to enable the client application to send a request to the intermediary server to check the status of one or more players indicated in the list of gaming contacts;
(b) The client chat facility enables the user thereof to create chat text messages and display chat text messages, which are delivered as between players by cooperation between the client chat facility and the server chat facility; the server chat facility also including a room manager facility that cooperates with the client chat facility associated with the wireless device and the at least one remote network-connected device to create and manage a plurality of chat rooms;
(c) The server contest facility enables the operator of the server computer to create and manage a series of contests in connection with one or more multi-player games, wherein the contests are implemented by cooperation between the server contest facility and the client contest facility;
(d) The client ranking facility is operable to communicate the results of a particular multi-player game to the server computer for storage to a ranking list established on the server database by the server ranking facility, the server ranking facility being operable to update the ranking list based on further results provided in subsequent multi-player games, providing ranking information to players on other players, and/or co-operating with the matching facility to match players with other players with similar ranking information; and
(e) The client SMS facility enables the user thereof to create SMS messages, which are delivered as between players by cooperation between the client SMS facility and the server SMS facility.
